(19) United States
(12) Patent Application Publication
(10) Pub. No.: US 2010/0076593 A1
(43) Pub. Date: Mar. 25, 2010

(54) Mail Item Sorting System with a Separating Switch to Divide the Transportation Line

(75) Inventors: Uwe Märtin, Konstanz (DE); Armin Zimmermann, Konstanz (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/306,753

(22) PCT Filed: Jun. 27, 2007
(86) PCT No.: PCT/EP2007/056397

§ 371 Date: Oct. 15, 2009

(30) Foreign Application Priority Data
Jun. 28, 2006 (DE) 10 2006 029 728.8

(51) Int. Cl. B07C 1/04; G06F 7/00

(52) U.S. Cl. 700/223

(57) ABSTRACT

A mail sorting system includes a transportation line for generating a mail stream of letters or postal items to be sorted, modules for processing the streaming mail and a delay device for reducing the speed of the mail stream from a first to a second speed. Separators divide the transportation line into two parallel lines, with the delay device being disposed in one parallel line. Mail can be transported slowly and therefore slower and simpler print modules can be used. Short transportation paths can be provided for time delay in the parallel lines, in such a way that the mail is handled carefully.

The invention is based on a mail item sorting system with a transportation line for generating a flow of mail items from a plurality of mail items to be sorted, which are arranged longitudinally one behind the other, modules for processing the flowing mail items and a separating switch to divide the transportation line into two parallel lines.

In mail item sorting systems mail items, for example letters, are separated from a stack and transported in a flow of mail items one behind the other, clamped between two belts, in a transportation line. A high transportation speed of a number of meters per second is required to achieve a high throughput. The transportation speed is determined by the throughput of mail items to be achieved multiplied by a path length, made up of the defined mail item length and a minimum distance between the mail items. Processing modules of the mail item sorting system, such as printers, image recognition devices and so on, have to be adjusted to this high speed and for example print a graphic, such as a stamp cancelation mark, on the mail items passing the print head. Such high-performance modules are expensive.

It is known from the published German patent application 1 574 747 that the flow of mail items can be divided into a number of parallel lines each with a coding point, so that the processing capacity of the mail item sorting system can be increased to a multiple of the maximum output of a coding point.

The object of the invention is to specify a mail item sorting system, in which a high mail item throughput can be associated with low-cost mail item processing modules.

This object is achieved by a mail item sorting system of the type mentioned in the introduction, which according to the invention has a delay means arranged in a parallel line to reduce the speed of the flow of mail items from a first to a second speed and a control unit to set a distance between mail items in the parallel lines, which is shorter than the distance between mail items immediately before the separating switch. The parallel lines allow the mail items in the flow of mail items to be divided up, with the result that large gaps can be created between the mail items. These large gaps allow a speed reduction, without the sequence of the mail items in the flow of mail items having to be changed. The mail items can be transported past processing modules at the lower second speed, said modules then only having to be designed for the lower second speed. In order to process both flows of mail items in an identical manner, each processing module must be present in pairs, with two slower processing modules in some instances being more favorable than a single high-performance module designed for high speeds.

The mail item sorting system can be a mail office sorting system, in particular a letter sorting system. A module can refer to a means for modifying the mail item, for example in respect of its position—apart from providing simple, destination-oriented transportation—or in respect of its components, e.g. by stamping. A module can be a means for positive or negative acceleration, for sorting, aligning, turning, imprinting, sticking, delaying—e.g. a holding path—separating, collecting and so on and can in particular be a means, which places more demands on the mail items than a spatially destination-oriented transportation system. Sorting by the mail item sorting system also includes processing the mail items in the form of sorting preparation, for example by applying a sorting code, such as an identity code, a destination location code and so on. Dividing the mail items up into at least two containers is also understood as sorting.

The transportation line can be divided into two or more parallel lines. The delay means allows not only individual mail items but also an entire flow of mail items, in other words a plurality of mail items arranged one behind the other, to be conveyed by the parallel line at the second speed. Each of the parallel lines advantageously comprises a delay means, with the result that identical modules can be used in the parallel lines. The second speed is not equal to zero and is advantageously in the range from 20% to 80% of the first speed and is expediently identical in the parallel lines.

In one advantageous embodiment of the invention the parallel lines are brought together by means of a merging point to form a continuing overall line. The mail items can thus be processed further, for example can be sorted, in a common flow of mail items.

In order to be able to ensure merging whilst still retaining the same sequence of mail items as before the separating switch, the parallel line are advantageously of such a length that the mail items pass through both parallel lines in the same time. In order to be able to use identical processing modules, an identical second speed in the parallel lines is advantageous. The parallel lines are expediently of identical length for this instance in particular.

Uncomplicated division of the mail items into the parallel lines irrespective of functions of the parallel lines can be achieved if the parallel lines each have the same type of module for processing the mail items. In particular both parallel lines are structured in an identical manner in respect of all the modules assigned to them. The mail items can be processed in an identical manner in both lines. The module can be a coding module, a sticking module, a print module, a read module and so on.

The slower second speed allows the mail items in the parallel line to be moved with a smaller mutual displacement between the belts transporting them. This allows a smaller minimum gap between the mail items, allowing a high throughput to be achieved by a parallel line. To this end the mail item sorting system has a control unit for setting a distance between mail items in the parallel lines, which is shorter than the distance between mail items immediately before the separating switch. This applies expediently to all distances between mail items transported at the second speed. In particular a transportation time interval is set between mail items in the parallel lines, which is shorter than the transportation time interval between mail items immediately before the separating switch. The transportation time interval is the interval between mail items divided by the transportation speed of the mail items.

It is also proposed that the mail item sorting system has a control unit for dividing the flow of mail items in the separating switch in the manner of a zip fastener. Gaps can be generated at regular intervals between the mail items, thereby allowing the speed of the flow of mail items to be significantly reduced without the mail items colliding. The two flows of mail items in the parallel lines are expediently brought together at a merging point likewise in the manner of a zip fastener, so that the mail items are in the same sequence after the parallel lines—in some instances apart from ejected items—as before the parallel lines.

In a further advantageous embodiment of the invention the parallel lines each have a means for increasing the speed of the flow of mail items, in particular to at least the speed of the flow of mail items immediately before the separating switch. This allows large gaps to be created between the mail items, into which mail items from another parallel line can be filtered so that the original sequence can be maintained.

A minimum second speed is a function of the first speed and the ratio between mail item lengths and gaps between the mail items before the separating switch. Mail item lengths can generally vary between a maximum mail item length of longest permissible mail items and a minimum mail item length of shortest permissible mail items. To allow a low second speed, at which the collision of mail items is reliably avoided, the mail item sorting system expediently comprises a control unit for controlling the second speed as a function of a mail item length of mail items in the flow of mail items. The mail item length can be a measured mail item length or a predetermined maximum or minimum length, which is stored in the control unit.

Simple control of the second speed can be achieved by a control unit for controlling the second speed in such a manner that the collision of mail items in the first parallel line is avoided by feeding the mail items in an alternating manner into the two parallel lines and by feeding only the longest permissible mail items into a first parallel line and only the shortest permissible mail items into a second parallel line. The bigger the ratio of maximum length to minimum length, the greater this safe second speed, which also allows such extreme division without collision. Expediently the second speed is essentially the lowest speed that satisfies the above condition.

In a further embodiment of the invention the mail item sorting system comprises a control unit for controlling the flow of mail items in a parallel line at a second speed, which is lower than the safe second speed, with the result that a low and therefore advantageous speed is achieved. In particular the control unit for controlling the second speed is prepared in such a manner that it is slower than half the first speed, in particular lower than 0.45 times the first speed. With extreme division is can happen that there is not space for all the mail items assigned to a parallel line in said parallel line. To identify this situation in particular the mail item sorting system can have a measuring means to capture lengths of the mail items in the flow of mail items. The measuring means expediently also serves to capture lengths of gaps between mail items.

If—due to the division—there is a large gap between two mail items in the parallel line, this gap can be reduced, for example in favor of an optionally extreme division somewhat further back in the flow of mail items. To this end in particular or more generally to regularize the gaps in the parallel line or to change a relative position of a mail item to adjacent mail items, the mail item sorting system advantageously has a gap correction module for positioning mail items in the flow of mail items in a parallel line.

A segregating means for segregating individual mail items from the flow of mail items is able to prevent mail items in a parallel line colliding, even in the case of extreme division. The segregating means can be arranged before or in a parallel line.

It is possible to counteract problems in a subsequent sorting operation with the aid of a gap correction module after a merging point in the parallel lines.

Images of handwritten addresses are generally output online to an employee, who reads the address and inputs it into a computer, so that the corresponding mail item can be coded according to the input. This takes some time, during which the mail item is transported in a transportation path for generating a time delay between a read module and a coding module. Such a transportation path can have a length of 40 m or more and a plurality of bends, which place significant mechanical demands on the mail items. The mail items can be preserved, if the transportation path is kept short. Since the time delay for reading the handwritten address is predetermined, the transportation path can be kept short, if the mail items pass through it slowly. Because the mail item lengths are predetermined, it is not possible to slow down a single flow of mail items to any significant degree, if the throughput is predetermined. If however in a further embodiment of the invention one transportation path for generating a time delay is arranged in each of the parallel lines, a mail item run in the transportation path can be considerably shortened, thereby preserving the mail items to a significant degree. The transportation path here serves as a time delay means and not primarily for transportation to a destination, as the transportation path is in particular longer than a technically expedient transportation route between modules it connects. The transportation path can be in one part or a number of parts, in other words interrupted by further modules.

In the case of an arrangement with one labeling module in each of the parallel lines, it is possible to use simple and low-cost modules.

The invention is described in more detail below with reference to exemplary embodiments illustrated in the drawings, in which:

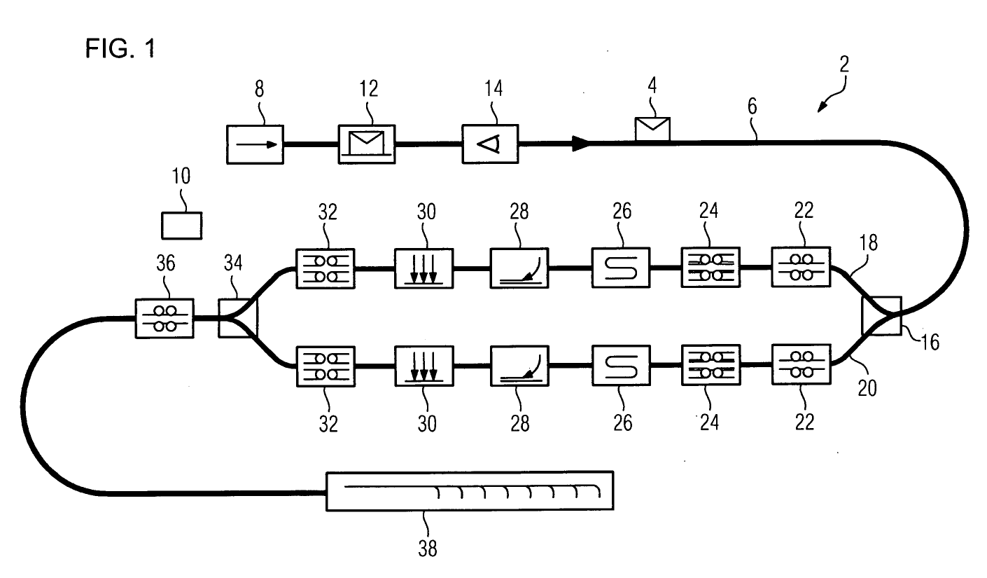

FIG. 1 shows a mail item sorting system with two parallel lines,

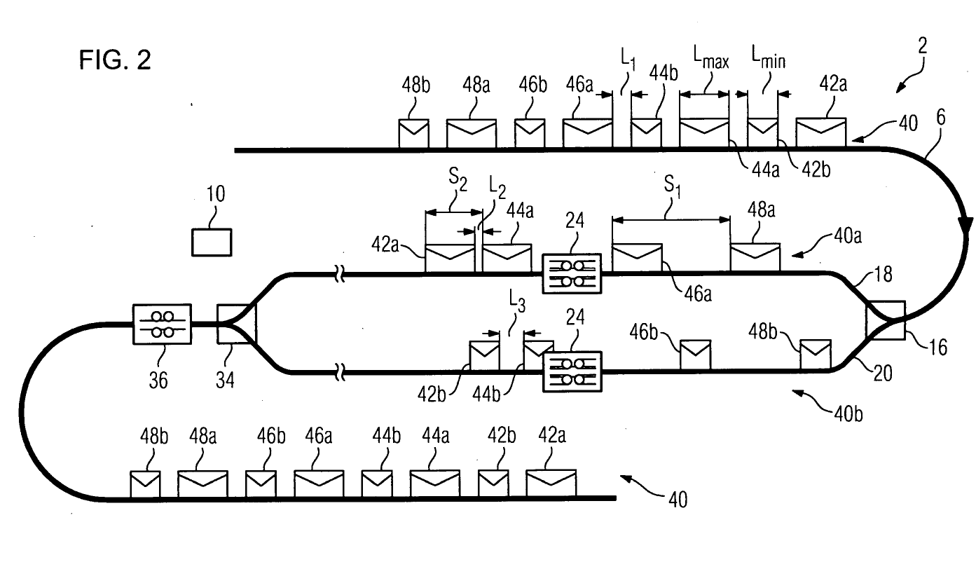

FIG. 2 shows a segment of the mail item sorting system from FIG. 1 with a number of flows of mail items and

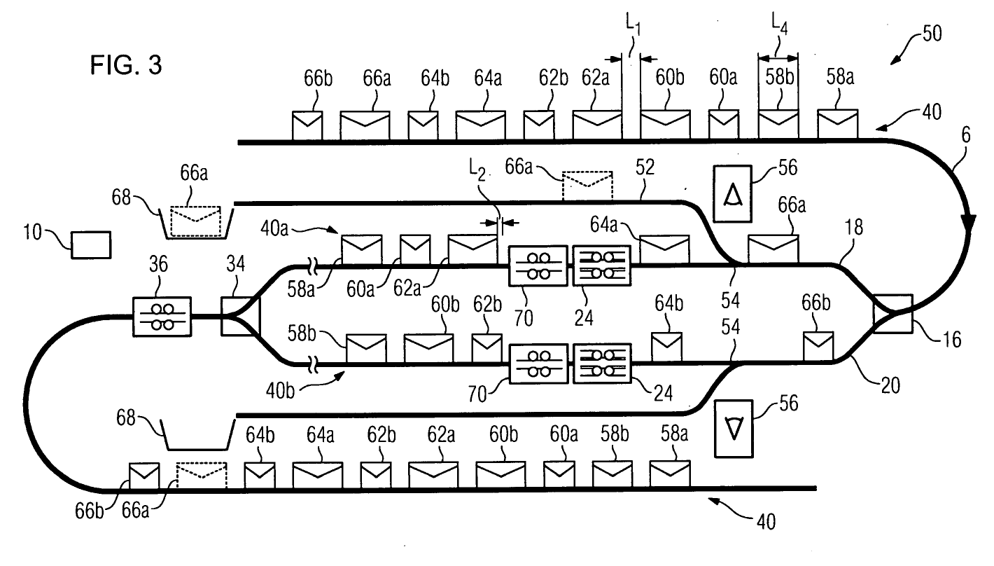

FIG. 3 shows a segment of a further mail item sorting system with more complex control of the flows of mail items.

FIG. 1 shows a schematic diagram of a mail item sorting system 2 with a number of modules for processing mail items 4 to be sorted at a transportation line 6 for transporting the mail items 4. The mail items 4 are first separated by a separating facility 8, also referred to as a feeder, and a predetermined distance is set between them by a control unit 10, which is connected for signal purposes to all the modules and further components of the mail item sorting system 2.

The mail items 4 thus separated are clamped between two elastic belts and transported by the transportation line 6 to an alignment unit 12, which aligns the passing mail items 4 at their lower edges. The mail items 4 are then conveyed by the transportation line 6 without interruption past a read device 14, for example a barcode read device, an address read device or an imaging device, which reads a barcode that may be present on mail items 24 or an address printed on the mail items 4 or records both sides of the mail item 4. As some mail items 4 have handwritten addresses, which cannot be recognized by the read device 14, the recordings of these mail items 4 are fed to the control unit 10, which sends the recordings online to a read center (not shown), in which the recordings are output on screens and read by personnel, who input at least parts of the address by way of a keyboard. This data is returned online to the control unit 10.

During the further course of the sorting method the mail items 4 are fed to a separating switch 16, which splits the transportation line 6 into two parallel lines 18, 20 of identical length and having the same type of modules. Both parallel lines 18, 20 comprise a gap correction module 22 for positioning the mail items 4 relative to one another in the flow of mail items. A delay means 24 or delay module slows down the flow of mail items moving at a first speed before the separating switch in each instance to a lower second speed in the parallel lines 18, 20. The second speed is identical in both parallel lines 18, 20. The gap correction modules 22 can also be arranged behind the delay means 24.

All the mail items 4 are now fed to approximately 20 m long transportation paths 26 for generating a time delay of around 12 seconds, giving the read personnel a few seconds to input the read address by keyboard, before the mail items 4 respectively reach an application module 28 for forwarding stickers to be stuck on as required and a labeling module 30, which prints a forwarding address on the forwarding sticker or a barcode on mail items 4 with addresses that cannot be machine-read. A means 32 for increasing the speed of the flow of mail items in the parallel lines 18, 20 is used to accelerate the mail items 4 back to the first speed or faster, with the result that large gaps again result between the mail items 4. The mail items 4 of the respective other parallel line 18, 20 are inserted into these gaps by a merging point 34, so that the mail items 4 reach a further gap correction module 36 back in their original order, said further gap correction module 36 regularizing the gaps between the mail items 4.

Finally the mail items 4 are conveyed by the transportation line 6 to a dividing apparatus 38, which distributes the mail items 4 to a plurality of containers according to their addresses. It is alternatively possible to have a dividing apparatus in only two collection points or a mail item collecting means to feed to a further sorting operation, for example in a second pass on the mail item sorting system 2 or another system.

FIG. 2 shows a segment of the mail item sorting system 2 from FIG. 1 with a flow of mail items 40 containing mail items 42a-b, 44a-b, 46a-b and 48a-b, which is divided in the parallel lines 18, 20 into two flows of mail items 40a, 40b containing the mail items 42a, 44a, 46a, 48a and/or 42b, 44b, 46b, 48b. To describe an extreme situation which is however randomly possible, the mail items 42a-48b in the flow of mail items 40 in FIG. 2 is arranged in such a manner that every second mail item 42a-48a is a longest permissible mail item with a maximum length Lₘₐₓ and the other mail items 42b-48b are shortest permissible mail items 42b-48b with a minimum length Lₘᵢₙ. The smallest permissible distance L₁ in the flow of mail items 40 is set between each of the mail items 42a-48b. With this extreme arrangement the separating switch 16 directs all the mail items 42a-48a into the parallel line 18 and all the mail items 42b-48b into the parallel line 20.

After the zip fastener type division of the mail items 42a-48b into the two transportation lines 18, 20, they are slowed down by the delay means 24 to the second speed. The control unit 10 also sets a very small distance L₂ between the mail items 42a-48a, which is shorter than the distance L₁ and which even at low second speed is passed through by the mail items 42a-48a more quickly than the distance L₁ with the high first speed. The second speed is hereby determined and controlled by the control unit 10 and results as follows. During a time period Δt the mail items 42a-48b in the flow of mail items 40 (and at the start of the parallel lines 18, 20) cover a path S₁ at the first speed v₁:

$${S}_{1} = Δ {tv}_{1} , \\ = {L}_{max} + {L}_{min} + 2 {L}_{1} .$$

During the same time period Δt the mail items 42a-48a in the flow of mail items 40a, in other words after the delay means 24, cover a path S₂ at the second speed v₂:

$${S}_{2} = Δ {tv}_{2} , \\ = {L}_{max} + {L}_{2} .$$

The equations can be resolved after Δt and the following results:

$${S}_{1} / {v}_{1} = {S}_{2} / {v}_{2}$$

$$\begin{matrix}{v}_{2} = {v}_{1} {S}_{2} / {S}_{1} \\ = {v}_{1} ( {L}_{max} + {L}_{2} ) / ( {L}_{max} + {L}_{min} + 2 {L}_{1} ) .\end{matrix}$$

With the following exemplary variables for standard letters:
Length Lₘₐₓ=240 mm
Length Lₘₐₓ=135 mm
Distance L₁=75 mm
Distance L₂=20 mm
Speed v₁=3.5 m/s

the following results:

$${v}_{2} = 0 , 495 {v}_{1} . \\ = 1.73 m \text{/} s$$

This second speed v₂ is the lowest speed, at which the mail items 42a-48a in the parallel line 18 do not collide, even with this illustrated extreme arrangement of mail items 42a-48b in the flow of mail items 40. The second speed v₂ is a function of the length difference between the length Lₘₐₓ and the length Lₘᵢₙ. The greater the length difference, the higher the second speed v₂. The second speed v₂ is also a function of the difference between the distances L₁ and L₂. The greater this difference, the lower the second speed v₂ can be set. The second speed v₂ is set by the control unit 10 according to the mail items transported by the mail item sorting system 2 and their dimensions. The distance L₃ between the mail items 42b-48b in the parallel line 20 results from the second speed v₂ and the length Lₘᵢₙ and has no essential significance.

FIG. 3 shows a further mail item sorting system 50, with which a speed v₃ in the parallel lines 18, 20 can be reduced below the safe speed v₂ resulting even with extreme distributions. The description which follows is restricted essentially to the differences compared with the exemplary embodiment in FIGS. 1 and 2, to which reference is made in respect of identical features and functions. Essentially identical components are in principle assigned the same reference characters. The mail item sorting system 50 has one segregating means 52 with a separating switch 54 in each of the two parallel lines 18, 20, before which a measuring means 56 for measuring the position and length of mail items 58a-66b is respectively arranged. The end of each segregating means 52 opens into a container 68 for receiving ejected mail items 66a. The segregating means 52 and the measuring means 56 can equally well be arranged in front of the separating switch 16, thereby simplifying the system.

In the example shown in FIG. 3 first two mail items 58a-b of roughly average length L₄, then one short and one long mail item 60a-b and then again an extreme distribution of longest mail items 62a-66a and shortest mail items 62b-66b in an alternating manner is arranged in the flow of mail items 40. The mail items 58a-66a are directed by the separating switch or subject to the control of the control unit 10 into the parallel line 18 and the mail items 58b-66b into the parallel line 20. The delay means 24 slows the mail items 58a-66b down to the speed v₃=0.43 v₁. The initially essentially regular distribution of the first mail items 58a-62b into long and short mail items 58a-62b means that adequate distances can be kept between them in the parallel lines 18, 20. Also the succession of the two longest mail items 62a-64a with simultaneous branching off of the shortest mail items 62b-64b can be compensated for by a gap correction module 70 by briefly holding back the mail item 64a so that the smallest permitted distance L₂ is maintained behind the delay means 24 in the parallel line 18. However the measuring means 56 signals that in the parallel line 18 another long mail item 66a follows the short mail item 64b in the parallel line 20. The control unit 10 uses a predetermined algorithm to calculate from this that the slow speed v₃ and the fast arrival of the mail item 66a due to the short mail item 64b means that a collision of subsequent mail items is probable or no longer avoidable and activates the separating switch 54 in such a manner that the mail item 66a is ejected into the segregating means 52. It lands in the container 68 and can be fed manually to the separating apparatus 8 for resorting.

After the flows of mail items 40a, 40b have merged to form the flow of mail items 40, the mail item 66a is missing from the flow of mail items 40. Otherwise the mail items 58a-66b are back in the same sequence as before the separating switch 16. The displacement of the mail item 64a by the gap correction module 70 is again compensated for by further displacement of the mail item 64a by the gap correction module 36.

The second speed v₂, v₃ can be adjusted by the control unit 10 to the modules active in the parallel lines 18, 20. It is the case here that the lowest possible second speed v₂, v₃ is advantageous in respect of the transportation paths 26, as this keeps the transportation paths 26 as short as possible and the mail items 4 can be preserved to the maximum. This does not have to be so with regard to the application modules 28 and labeling modules 30. If these devices are suitable for example up to a speed of 1.75 m/s, in other words for example 0.5 v₁, a further reduction of second speed v₂ is not necessary. If it should happen however that mail items 4 with extreme length differences are sorted in a pass, a control method as described in relation to FIG. 3 may be necessary, in order to be able to achieve the second speed v₂=1.75 m/s. The control unit 10 makes this calculation and outputs corresponding information to an operator. It is also possible for a slow module to be used for a first pass and the control unit 10 therefore to control the method described in relation to FIG. 3 and the slow module not to be required and to be deactivated in a second pass. The control unit 10 can now control the method described in relation to FIG. 2—as a function of the active modules of the mail item sorting system 2, 50—and signal to the operator that the container 68 is now no longer needed.

1-15. (canceled)

16. A mail item sorting system, comprising:
a transportation line for generating a flow of mail items from a multiplicity of mail items disposed longitudinally one behind the other for sorting;
modules for processing the flowing mail items;
a separator dividing said transportation line into two parallel lines;
a delay device disposed in one of said parallel lines for reducing a speed of said flow of mail items from a first speed to a second speed; and
a control unit for setting a distance between the mail items in said parallel lines being shorter than a distance between the mail items immediately upstream of said separator.

17. The mail item sorting system according to claim 16, which further comprises a merging location at which said parallel lines are brought together to form a continuing overall line.

18. The mail item sorting system according to claim 16, wherein said parallel lines have identical lengths.

19. The mail item sorting system according to claim 16, wherein said modules for processing the flowing mail items are of the same type in each of said parallel lines.

20. The mail item sorting system according to claim 16, wherein said control unit divides said flow of mail items in said separator by alternate filtering-in.

21. The mail item sorting system according to claim 16, wherein said parallel lines each have a device for increasing said speed of said flow of mail items.

22. The mail item sorting system according to claim 16, wherein said parallel lines each have a device for increasing said speed of said flow of mail items to a speed of said flow of mail items immediately upstream of said separator.

23. The mail item sorting system according to claim 16, wherein said control unit controls said second speed as a function of a mail item length of mail items in said flow of mail items.

24. The mail item sorting system according to claim 16, wherein said control unit controls said second speed for avoiding a collision of the mail items in said first parallel line when the mail items are fed in an alternating manner into said two parallel lines and when only longest permissible mail items are fed into a first one of said parallel lines and only shortest permissible mail items are fed into a second one of said parallel lines.

25. The mail item sorting system according to claim 16, which further comprises a measuring device for capturing lengths of the mail items in said flow of mail items.

26. The mail item sorting system according to claim 16, wherein said control unit controls said second speed to be slower than half of said first speed.

27. The mail item sorting system according to claim 16, which further comprises a gap correction module for positioning the mail items in said flow of mail items in a parallel line.

28. The mail item sorting system according to claim 16, which further comprises a segregating device for segregating mail items from said flow of mail items.

29. The mail item sorting system according to claim 17, which further comprises a gap correction module downstream of said merging location of said parallel lines.

30. The mail item sorting system according to claim 16, which further comprises transportation paths each disposed in a respective one of said parallel lines for generating a time delay.

31. The mail item sorting system according to claim 16, which further comprises labeling modules each disposed in a respective one of said parallel lines.
